(19) United States
(12) Patent Application Publication
(10) Pub. No.: US 2011/0102727 A1
(43) Pub. Date: May 5, 2011

(54) LIQUID CRYSTAL DISPLAY PANEL

(76) Inventor: Shinichi Hirato, Osaka-shi (JP)

(21) Appl. No.: 12/674,027

(22) PCT Filed: Sep. 12, 2008
(86) PCT No.: PCT/JP2008/066581

§ 371 Date: Feb. 18, 2010

(30) Foreign Application Priority Data
Oct. 29, 2007 (JP) 2007-280942

(51) Int. Cl. G02F 1/1339

(52) U.S. Cl. 349/153

(57) ABSTRACT

A first end-sealing member (23) is provided between a matrix substrate (2) and a counter substrate (3), on an outer circumferential side of a liquid crystal display panel as compared to a control circuit (5), so as to be away from the control circuit (5); a second end-sealing member (22) is provided between the matrix substrate (2) and the counter substrate (3), along a boundary between a first region where the control circuit (5) is provided and a second region where a display section is provided, the first region including: a third region which is allotted for the control circuit (5); and a fourth region which is allotted for no control circuit (5), so as to be away from the control circuit (5); and spacers (31) are provided in the fourth region included in the first region, so as to maintain a distance between the matrix substrate (2) and the counter substrate (3), the first region being end-sealed, with part of the first end-sealing member (23) and the second end-sealing member (22), separately from the second region in which liquid crystal is sealed. This realizes a liquid crystal display panel which is capable of preventing (i) intrusion of a foreign material in a control circuit from an end-sealing member and (ii) the control circuit from being stressed.

### TECHNICAL FIELD

The present invention relates to a technique for liquid crystal end-sealing which is employed in a liquid crystal display panel.

### BACKGROUND ART

Patent Literature 1 discloses a technique for liquid crystal end-sealing which allows a reduction in mounting area and an improvement in reliability in a case where a control circuit for a matrix circuit is formed on a liquid crystal display panel in a COG (Chip On Glass) method.

FIG. 14 illustrates an arrangement for liquid crystal end-sealing which is disclosed in Patent Literature 1. An end-sealing member 123 is provided, for the end-sealing of a liquid crystal layer LC between a TFT substrate 102 and a counter substrate 103, so as to cover a control circuit 105 (see FIG. 14). The liquid crystal layer LC is end-sealed with the end-sealing member 123 and an end-sealing member 132 which is separately provided in a circumferential part of the liquid crystal display panel. Bus lines 115 which are included in the matrix circuit are first connected to respective short rings 116. The bus lines 115 are cut by laser-irradiation at their respective cutting parts 117 after being subjected to a rubbing process. This prevents an electrostatic breakdown from occurring in pixel TFTs while the pixel TFTs are being produced.

A top surface of the sealing member 123 is in contact with a surface of the counter substrate 103 which surface faces the TFT substrate 102. The counter substrate 103 is partially removed in its part where it is in contact with the end-sealing member 123. This is because the control circuit 105 has a height from a top surface of the TFT substrate 102 which height is higher than the matrix circuit which is provided on the top surface of the TFT substrate 102 and which includes constituents such as the bus lines 115.

### CITATION LIST

### Patent Literature 1

Japanese Patent Application Publication, Tokukaihei, No. 9-171193 A (Publication Date: Jun. 30, 1997)

### Patent Literature 2

Japanese Patent Application Publication, Tokukai, No. 2005-92044 A (Publication Date: Apr. 7, 2005)

### Patent Literature 3

Japanese Patent Application Publication, Tokukai, No. 2002-327030 A (Publication Date: Nov. 15, 2002)

### SUMMARY OF INVENTION

However, since the control circuit 105 is covered with the end-sealing member 123 according to the arrangement illustrated in FIG. 14, there will occur the following problems: (i) the control circuit 105 may corrode due to a material, contained in the end-sealing member 123, such as a chlorinated material; and (ii) metal ions such as Na ions may directly flow into the control circuit 105 via moisture in a case where the liquid crystal display panel is exposed to a humidity environment. Further, even if there occurs an improvement in such a problem of intrusion of a foreign material, the end-sealing member 123 is in contact with a region of the counter substrate 103 which region is defined by a width W having a millimeter order (see FIG. 15). This causes the counter substrate 103 to be greatly stressed due to hardening and shrinkage of the end-sealing member 123. This causes the counter substrate 103 to deform (see a two-dot chain line as illustrated in FIG. 15), so that display unevenness occurs due to a change in cell thickness of a display area.

Note that such problems similarly occur in a case where the control circuit 105 is made of a material, formed on the liquid crystal display panel, such as CG (Continuous Grain) silicon.

The present invention has been made in view of such conventional problems as described above, and its object is to realize a liquid crystal display panel which is capable of preventing (i) a foreign material from being intruded into a control circuit from an end-sealing member and (ii) the control circuit from being stressed.

In order to achieve the object, a liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a second end-sealing member provided between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the first region being end-sealed, with part of the first end-sealing member and the second end-sealing member, separately from the second region in which the liquid crystal is sealed.

According to the invention, the control circuit is away from each of the first and second end-sealing members, and the spacers maintain the distance between the matrix substrate and the counter substrate, in the first region. This allows the first region to be stably maintained as an end-sealing space. The control circuit is in contact with no first and second end-sealing members. This prevents a foreign material from moving and directly being intruded into the control circuit from the end-sealing member. Further, this also prevents the control circuit from being stressed.

The above brings about an effect of realizing a liquid crystal display panel which is capable of preventing (i) intrusion of a foreign material in a control circuit from an end-sealing member and (ii) the control circuit from being stressed.

In order to achieve the object, the liquid crystal display panel of the present invention is arranged such that a space, defined by end-sealing the first region, is decompressed.

According to the invention, the space, defined by end-sealing the first region, is decompressed. Therefore, there are few substances which are in contact with the control circuit. This brings about an effect that a foreign material is extremely hard to be intruded into the control circuit.

In order to achieve the object, the liquid crystal display panel of the present invention is arranged such that the first end-sealing member is provided so as to cover outsides of respective edges of the matrix substrate and the counter substrate, which edges are located on the outer circumferential side of the liquid crystal display panel as compared to the control circuit.

The invention brings about an effect of allowing the first end-sealing member to strengthen the end-sealing of the respective edges of the matrix substrate and the counter substrate which edges face each other.

In order to achieve the object, the liquid crystal display panel of the present invention is arranged such that each of the first end-sealing member and the second end-sealing member is made of modified epoxy acrylate.

The invention brings about an effect of favorably forming the first end-sealing member and the second end-sealing member.

In order to achieve the object, the liquid crystal display panel of the present invention is arranged such that the first end-sealing member is made of a harder material than the second end-sealing member.

According to the invention, where the respective edges of the matrix substrate and the counter substrate which edges face each other are located is sealed with the end-sealing member which is made of a harder material than the second end-sealing member. This brings about an effect of causing the second end-sealing member to be robust to bending caused in the liquid crystal display panel and to cause the first end-sealing member to strongly support the edges of the matrix substrate and the counter substrate which face each other.

In order to achieve the object, the liquid crystal display panel of the present invention is arranged such that the first end-sealing member is made of acrylic resin or thiol, and the second end-sealing member is made of modified epoxy acrylate.

The invention brings about an effect of favorably forming the first end-sealing member and the second end-sealing member.

In order to achieve the object, the liquid crystal display panel of the present invention is arranged such that each of the first end-sealing member and the second end-sealing member includes glass spacers.

The invention brings about an effect of favorably forming the first end-sealing member and the second end-sealing member.

In order to achieve the object, the liquid crystal display panel of the present invention is arranged such that a first part of the counter substrate, which part faces the matrix substrate and corresponds to: (i) the first region, (ii) a region where the first end-sealing member is provided, and (iii) a region where the second end-sealing member is provided, is removed from the counter substrate so that a second part of the counter substrate obtained after the first part is removed has a smaller thickness than a third part of the counter substrate which part corresponds to the second region.

The invention brings about an effect of easily causing the control circuit to have nothing in contact with the counter substrate even if the control circuit has a height from a top surface of the matrix substrate which height is higher than the matrix circuit which is provided on the top surface of the matrix substrate.

In order to achieve the object, a liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a supporting member provided for supporting a gap between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the liquid crystal being integrally end-sealed with part of the first end-sealing member so that the first region and the second region communicate with each other.

According to the invention, the control circuit is away from each of the first end-sealing member and the supporting member, and the spacers maintain the distance between the matrix substrate and the counter substrate, in the first region. This allows the first region to be stably maintained as an end-sealing space. The control circuit is in contact with no first end-sealing member and no supporting member. This prevents a foreign material from moving and directly being intruded into the control circuit from the end-sealing member. Further, this also prevents the control circuit from being stressed.

The above brings about an effect of realizing a liquid crystal display panel which is capable of preventing (i) intrusion of a foreign material in a control circuit from an end-sealing member and (ii) the control circuit from being stressed.

In order to achieve the object, the liquid crystal display panel of the present invention is arranged such that a first part of the counter substrate, which part faces the matrix substrate and corresponds to: (i) the first region, (ii) a region where the first end-sealing member is provided, and (iii) a region where the supporting member is provided, is removed from the counter substrate so that a second part of the counter substrate obtained after the first part is removed has a smaller thickness than a third part of the counter substrate which part corresponds to the second region.

The invention brings about an effect of easily causing the control circuit to have nothing in contact with the counter substrate even if the control circuit has a height from a top surface of the matrix substrate which height is higher than the matrix circuit which is provided on the top surface of the matrix substrate.

In order to achieve the object, the liquid crystal display panel of the present invention is arranged such that each of the first end-sealing member and the supporting member includes glass spacers.

The invention brings about an effect of favorably forming the first end-sealing member and the supporting member.

In order to achieve the object, the liquid crystal display panel of the present invention is arranged such that the spacers provided in the first region are larger than spacers provided in the liquid crystal provided in the second region.

The invention brings about an effect of securing (i) a constant distance between the matrix substrate and the counter substrate in the first region and (ii) a constant distance between the matrix substrate and the counter substrate in the second region.

In order to achieve the object, the liquid crystal display panel of the present invention is arranged such that the spacers provided in the first region are made of a photospacer or a plastic bead.

The invention brings about an effect of favorably forming the spacers provided in the first region.

In order to achieve the object, a liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; and spacers, provided along a boundary between (a) a first region where the control circuit is provided and (b) a second region where the display section is provided, for maintaining, in a region corresponding to the first region, a distance between the matrix substrate and the counter substrate, the liquid crystal being integrally end-sealed with part of the first end-sealing member so that the first region and the second region communicate with each other.

According to the invention, the control circuit is away from the first end-sealing member, and the spacers maintain the distance between the matrix substrate and the counter substrate, along the boundary between the first region and the second region. This allows the first region to be stably maintained as an end-sealing space. The control circuit is in contact with no first member. This prevents a foreign material from moving and directly being intruded into the control circuit from the end-sealing member. Further, this also prevents the control circuit from being stressed.

The above brings about an effect of realizing a liquid crystal display panel which is capable of preventing (i) intrusion of a foreign material in a control circuit from an end-sealing member and (ii) the control circuit from being stressed.

In order to achieve the object, the liquid crystal display panel of the present invention is arranged such that a first part of the counter substrate, which part faces the matrix substrate and corresponds to: (i) the first region, (ii) a region where the first end-sealing member is provided, and (iii) a region where the spacers are provided, is removed from the counter substrate so that a second part of the counter substrate obtained after the first part is removed has a smaller thickness than a third part of the counter substrate which part corresponds to the second region.

The invention brings about an effect of easily causing the control circuit to have nothing in contact with the counter substrate even if the control circuit has a height from a top surface of the matrix substrate which height is higher than the matrix circuit which is provided on the top surface of the matrix substrate.

In order to achieve the object, the liquid crystal display panel of the present invention is arranged such that the counter substrate has a uniform thickness.

The invention brings about an effect such that it is unnecessary to transform a thickness of the counter substrate in a case where there is a small difference in height from the top surface of the matrix substrate between the control circuit and the matrix circuit.

In order to achieve the object, the liquid crystal display panel of the present invention is arranged such that the first end-sealing member is made of modified epoxy acrylate.

The invention brings about an effect of favorably forming the first end-sealing member.

In order to achieve the object, the liquid crystal display panel of the present invention is arranged such that the first end-sealing member includes glass spacers.

The invention brings about an effect of favorably forming the first end-sealing member.

In order to achieve the object, the liquid crystal display panel of the present invention is arranged such that the spacers provided along the boundary between the first region and the second region are larger than spacers provided in the liquid crystal provided in the second region.

The invention brings about an effect of securing (i) a constant distance between the matrix substrate and the counter substrate in the first region and (ii) a constant distance between the matrix substrate and the counter substrate in the second region.

In order to achieve the object, the liquid crystal display panel of the present invention is arranged such that the spacers provided along the boundary between the first region and the second region are made of a photospacer or a plastic bead.

The invention brings about an effect of favorably forming the spacers provided along the boundary between the first region and the second region.

In order to achieve the object, the liquid crystal display panel of the present invention is arranged such that the control circuit has a height from a top surface of the matrix substrate which height is higher than the matrix circuit in the second region.

Even if a liquid crystal display panel is typically arranged such that a counter substrate is more likely to be subjected to a change in thickness in a region where a control circuit is provided than in a region where a display region is provided, the invention brings about an effect of realizing a liquid crystal display panel which is capable of preventing (i) intrusion of a foreign material in a control circuit from an end-sealing member and (ii) the control circuit from being stressed.

In order to achieve the object, the liquid crystal display panel of the present invention is arranged such that the control circuit is made of CG silicon which is formed on the matrix substrate.

The invention brings about an effect of preventing a foreign material from being intruded into the control circuit which is made of CG silicon and to prevent the control circuit from being stressed.

In order to achieve the object, the liquid crystal display panel of the present invention is arranged such that the control circuit is mounted on the matrix substrate in a COG method.

The invention brings about an effect of preventing a foreign material from being intruded into the control circuit which is made of CG silicon and to prevent the control circuit from being stressed.

For a fuller understanding of the nature and advantages of the invention, reference should be made to the ensuing detailed description taken in conjunction with the accompanying drawings.

### BRIEF DESCRIPTION OF DRAWINGS

FIG. 1, which shows an embodiment of the present invention, is a cross-sectional view illustrating a first example of an arrangement for liquid crystal end-sealing.

FIG. 2, which shows the embodiment of the present invention, is a cross-sectional view illustrating a second example of the arrangement for the liquid crystal end-sealing.

FIG. 3, which shows the embodiment of the present invention, is a cross-sectional view illustrating a third example of the arrangement for the liquid crystal end-sealing.

FIG. 4, which shows the embodiment of the present invention, is a cross-sectional view illustrating a fourth example of the arrangement for the liquid crystal end-sealing.

FIG. 5, which shows the embodiment of the present invention, is a plan view illustrating a first arrangement of a liquid crystal display panel.

FIG. 6, which shows the embodiment of the present invention, is a plan view illustrating a second arrangement of the liquid crystal display panel.

FIG. 7 is a plan view illustrating a production process of the arrangement for the liquid crystal end-sealing of FIG. 1, and (a) through (e) of FIG. 7 illustrate respective steps.

FIG. 8 is a plan view illustrating a first modification of the production process illustrated in FIG. 7, and (a) through (e) of FIG. 8 illustrate respective steps.

FIG. 9 is a plan view illustrating a second modification of the production process illustrated in FIG. 7, and (a) through (e) of FIG. 9 illustrate respective steps.

FIG. 10 is a plan view illustrating a production process of the arrangement for the liquid crystal end-sealing of FIG. 2, and (a) through (e) of FIG. 10 illustrate respective steps.

FIG. 11 is a plan view illustrating a modification of the production process illustrated in FIG. 10, and (a) through (d) of FIG. 11 illustrate respective steps.

FIG. 12 is a plan view illustrating a production process of the arrangement for the liquid crystal end-sealing of each of FIGS. 3 and 4, and (a) through (e) of FIG. 12 illustrate respective steps.

FIG. 13 is a plan view illustrating a modification of the production process illustrated in FIG. 12, and (a) through (e) of FIG. 13 illustrate respective steps.

FIG. 14, which shows a prior art, is a cross-sectional view illustrating an arrangement for the liquid crystal end-sealing.

FIG. 15 is a cross-sectional view illustrating a problem of the arrangement for the liquid crystal end-sealing of FIG. 14.

### REFERENCE SIGNS LIST

1, 10 Liquid crystal display panel
2 TFT substrate (Matrix substrate)
3 Counter substrate
4 Display section
5 Control circuit
22 End-sealing member (Second end-sealing member, Supporting member)
23 End-sealing member (First end-sealing member)
24 End-sealing member (First end-sealing member)
31 Spacer
33 Spacer
34 Spacer
LC Liquid crystal

### DESCRIPTION OF EMBODIMENTS

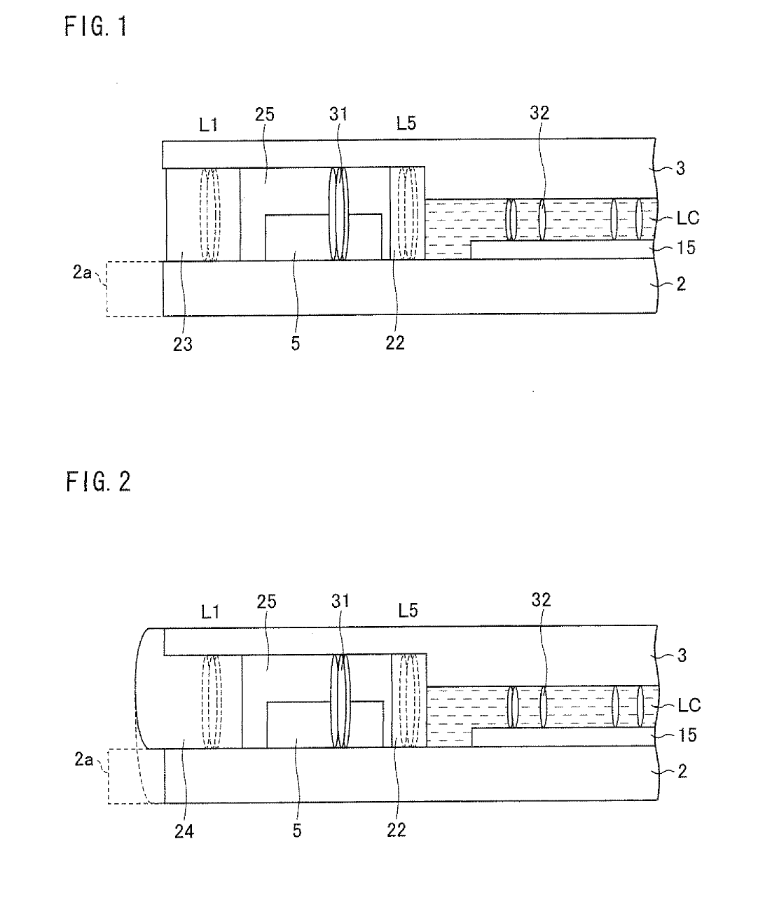

An embodiment of the present invention is described below with reference to FIGS. 1 through 13.

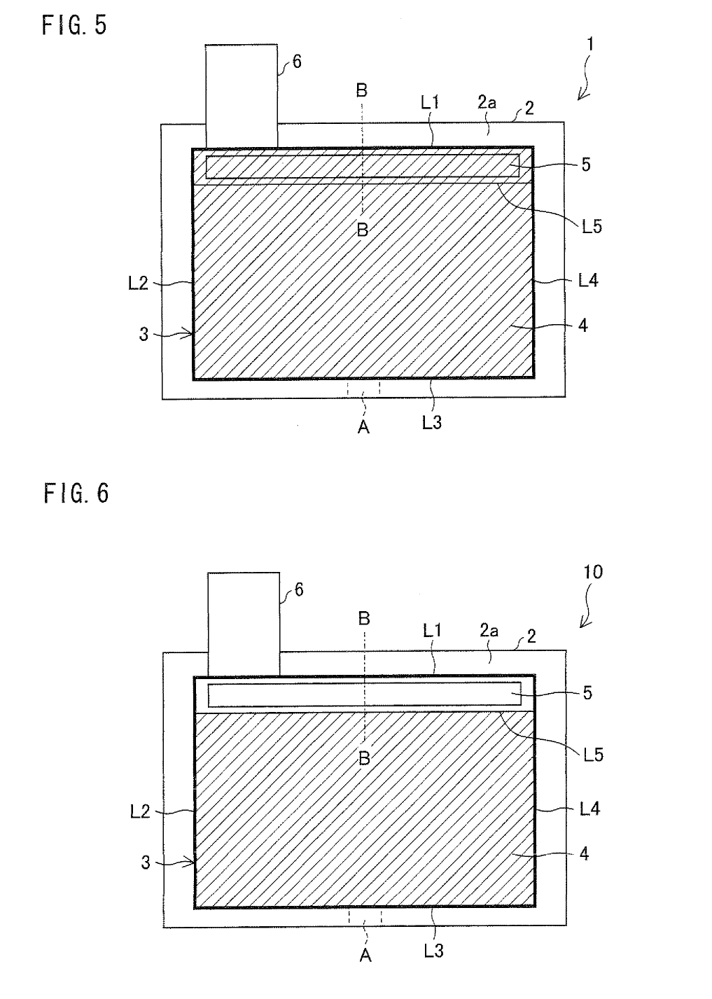

FIG. 5 illustrates a plan view of a liquid crystal display panel 1 which has an arrangement for end-sealing of the present embodiment.

The liquid crystal display panel 1 is arranged such that (i) a TFT substrate (matrix substrate) 2 and a counter substrate 3 are combined with each other and (ii) a flexible substrate 6 for supplying power-supply voltages and signals is connected to the TFT substrate 2 and the counter substrate 3 thus combined.

The TFT substrate 2 includes a glass substrate, a display section 4 including a matrix circuit, and a control circuit 5 which controls the display section 4, the display section 4 and the control circuit 5 being provided on the glass substrate. The control circuit 5 can be made of CO silicon which is formed on the TFT substrate 2 or alternatively can be mounted in a COG method. Note that there is no limitation as to how the control circuit 5 is provided. The present embodiment discusses the case where the control circuit 5 is provided only in a single region which is adjacent to the display section 4. The present embodiment, however, is not limited to this. Namely, a plurality of the control circuits 5 can be provided in a respective plurality of regions each of which is adjacent to the display section 4.

The counter substrate 3 is provided, in a rectangular region surrounded by four sides L1, L2, L3, and L4, so as to include (i) a region where the display section 4 is provided and (ii) a region where the control circuit 5 is provided. The side L3 is located on the opposite side of the side L1. The side L1 is located so as to be closer to the control circuit 5, whereas the side L3 is located so as to be closer to the display section 4. Each of the sides L2 and L4 is orthogonal to the sides L1 and L3. The counter substrate 3 is smaller in area than the TFT substrate 2. This produces an outer circumferential region 2a. The counter substrate 3 does not have a part which corresponds to the outer circumferential region 2a.

An end-sealing member for liquid crystal end-sealing is provided between the TFT substrate 2 and the counter substrate 3 along the sides L1, L2, L3, and L4. A shaded region shows an area which the liquid crystal is sealed. Note here that an entire region surrounded by the sides L1, L2, L3, and L4 serves as the area in which the liquid crystal is sealed. Note also that in a case where a boundary between the region where the display section 4 is provided and the region where the control circuit 5 is provided is referred to as L5, it is also possible to provide an end-sealing member along the boundary L5. In a case where the end-sealing member is provided along an entire length of the boundary L5, the region where the display section 4 is provided serves as the area in which the liquid crystal is sealed (see a shaded area of a liquid crystal display panel 10 illustrated in FIG. 6).

In a case where the liquid crystal is sealed by injection, a filling hole A is provided in the liquid crystal display panel so that the liquid crystal is filled from a given one of the sides L1, L2, L3, and L4 (here, from the side L3, for example). The filling hole A is end-sealed after the liquid crystal is filled therethrough.

The flexible substrate 6 is externally connected, on an outer circumferential side of the control circuit 5, on the TFT substrate 2.

Next, the following describes an arrangement of a cross section taken along the line B-B in each of FIGS. 5 and 6, with reference to Examples. In the arrangement, the region where the control circuit 5 is provided and the region where the display section 4 is provided are sectioned by a plane which is orthogonal to each of the side L1 and the boundary L5.

### Example 1

FIG. 1 illustrates an arrangement for liquid crystal end-sealing of the present example.

The present example is arranged such that: an end-sealing member (a first end-sealing member) 23 is provided along an entire length of the side L1, and an end-sealing member (a second end-sealing member) 22 is provided along the entire length of the boundary L5 which is located on an inner side of the liquid crystal display panel as compared to the control circuit 5. Each of the end-sealing members 22 and 23 is provided so as to be away from the control circuit 5. A space 25, including the control circuit 5, which is surrounded by the end-sealing members 22 and 23 and an end-sealing member provided along the sides L2 and L4 is a space decompressed by evacuation. Each of the end-sealing members 22 and 23 is made of, for example, a soft material such as UV curing modified epoxy acrylate. The control circuit 5 has a width of, for example, approximately 0.5 mm to 2 mm along the line B-B illustrated in each of FIGS. 5 and 6.

Further, the control circuit 5 has a height from a top surface of the TFT substrate 2 which height is higher than the matrix circuit which is provided on the top surface of the TFT substrate 2 and which includes constituents such as bus lines 15. Therefore, since the counter substrate 3 which surface faces the TFT substrate 2 is partially removed, the counter substrate 3 is arranged so as to have a smaller thickness in parts which correspond to the space 25 and the end-sealing members 22 and 23 than in a part where the region where the display section 4 is provided is sandwiched between the counter substrate 3 and the TFT substrate 2.

In the space 25, a constant distance is maintained between the TFT substrate 2 and the counter substrate 3 by spacers 31 each having a larger size than spacers 32 provided in liquid crystal LC in the region where the display section 4 is provided. The spacers 31 are provided, by inkjet fixed-point dispersion, in a region such as in a gap between circuits which are provided in the control circuit 5 so as to be adjacent to each other in a direction in which the side L1 extends. The provision of the spacers 31 is controlled so that no spacer 31 is provided on the control circuit 5. A photospacer, PB (a plastic bead) for fixed-point fixing (refer to Patent Literature 3, for example), or the like can be used as each of the spacers 31 and 32. Further, each of the end-sealing members 22 and 23 includes glass (silica) spacers.

A method such as an ODF (One Drop Fill) method or an injection method can be employed for the liquid crystal end-sealing.

Note that it is possible to provide no outer circumferential region 2a which is described with reference to FIGS. 5 and 6, i.e., it is possible for the TFT substrate 2 and the counter substrate 3 to have an identical area (see a dashed line in FIG. 1).

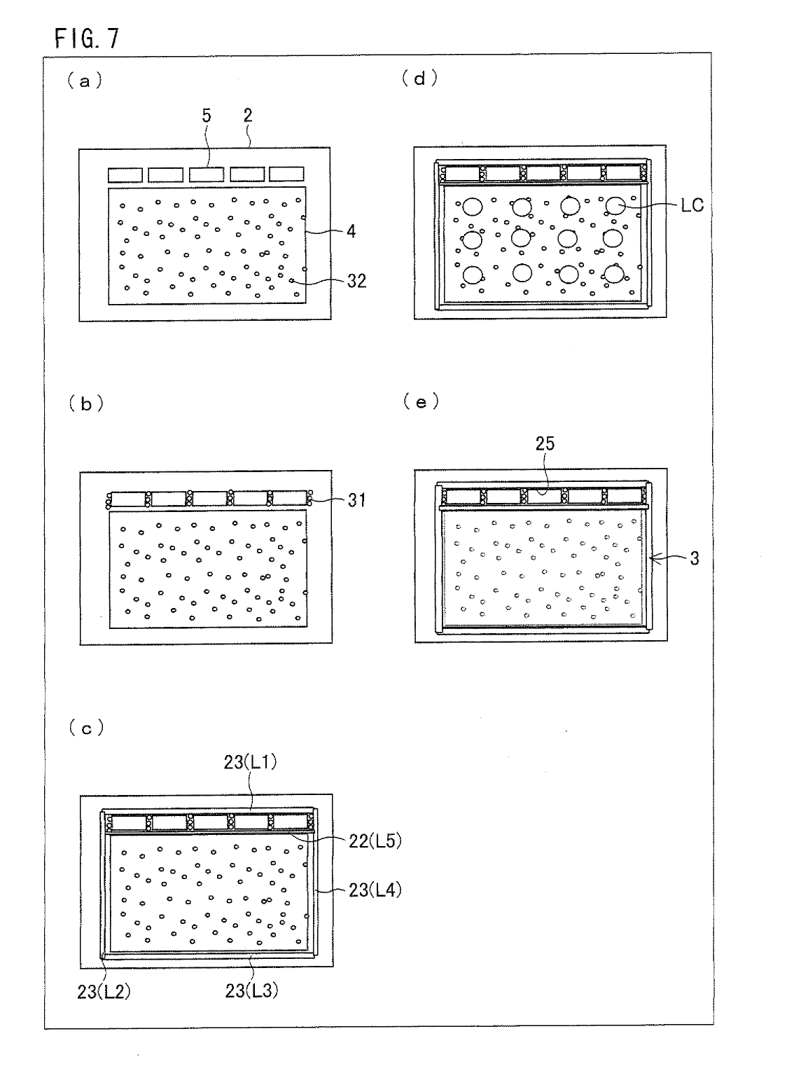

Next, the following describes a process for the liquid crystal end-sealing which is carried out in each of the liquid crystal display panels 1 and 10, with reference to (a) through (e) of FIG. 7.

The spacers 32 are dispersed in the region where the display section 4 is provided, the display section 4 and the control circuits 5 being provided on the TFT substrate 2 (see (a) of FIG. 7). The spacers 31 are provided, by the inkjet fixed-point dispersion, in the region where the control circuits are provided, in a gap between the respective control circuits 5 (see (b) of FIG. 7). The end-sealing member 23 is provided along entire lengths of the respective sides L1, L2, L3, and L4, and the end-sealing member 22 is provided along the entire length of the boundary L5 (see (c) of FIG. 7). In order that the liquid crystal is sealed in the ODF method, the liquid crystal LC is dropped in the region where the display section 4 is provided (see (d) of FIG. 7). The TFT substrate 2 and the counter substrate 3 are combined with each other, and UV curing or heat curing is then carried out, so that the liquid crystal is sealed (see (e) of FIG. 7). The space 25 where the control circuits 5 are provided is evacuated.

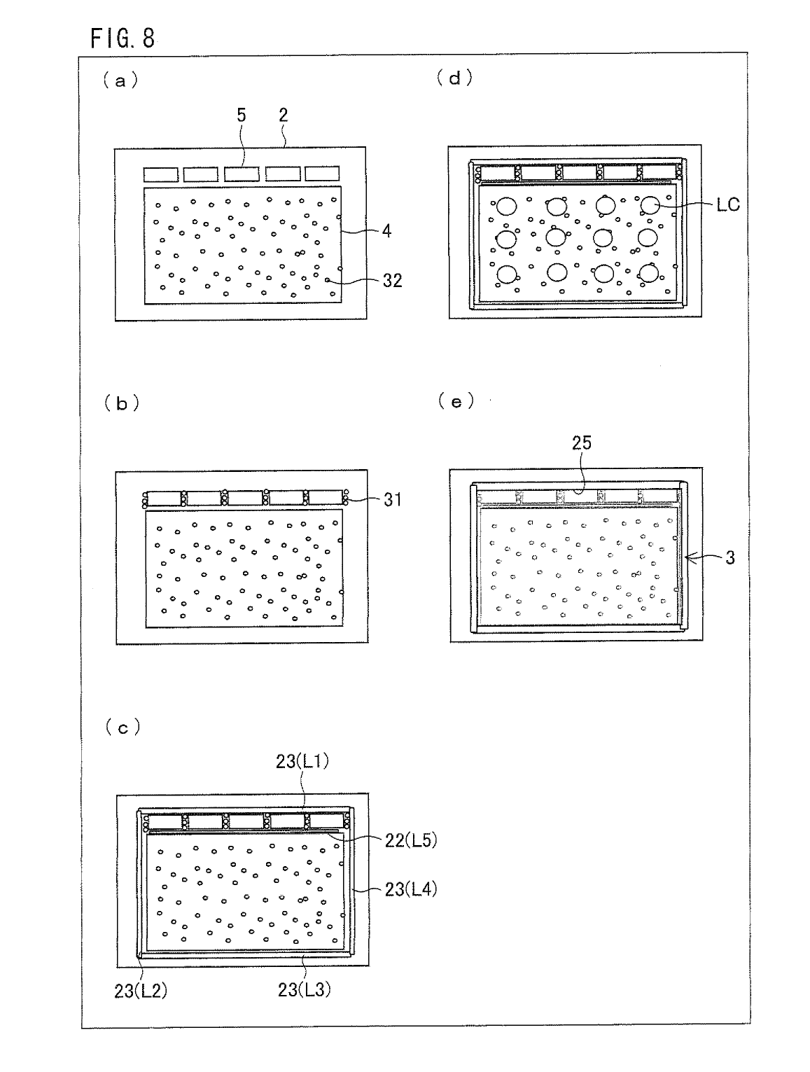

Note that it is also possible to carry out steps which are slightly different from those of FIG. 7 in arrangement for the liquid crystal end-sealing (see (a) through (e) of FIG. 8).

Steps identical to those of (a) and (b) of FIG. 7 are carried out (see (a) and (b) of FIG. 8). Next, the end-sealing member 23 is provided along the entire lengths of the respective sides L1, L2, L3, and L4, and the end-sealing member (supporting member) 22 is partially provided along the boundary L5, not along the entire length of the boundary L5 (see (e) of FIG. 8). In order that the liquid crystal is sealed in the ODF method, the liquid crystal LC is dropped in the region where the display section 4 is provided or both in the region where the display section 4 is provided and in the region where the control circuit 5 is provided (see (d) of FIG. 8). The TFT substrate 2 and the counter substrate 3 are combined with each other, and UV curing or heat curing is then carried out, so that the liquid crystal is sealed (see (e) of FIG. 8). The region where the display section 4 is provided and the region where the control circuit 5 is provided communicate with each other via a region where no end-sealing member 22 is provided along the boundary L5. As such, the liquid crystal LC is integrally sealed both in the region where the display section 4 is provided and in the region where the control circuit 5 is provided.

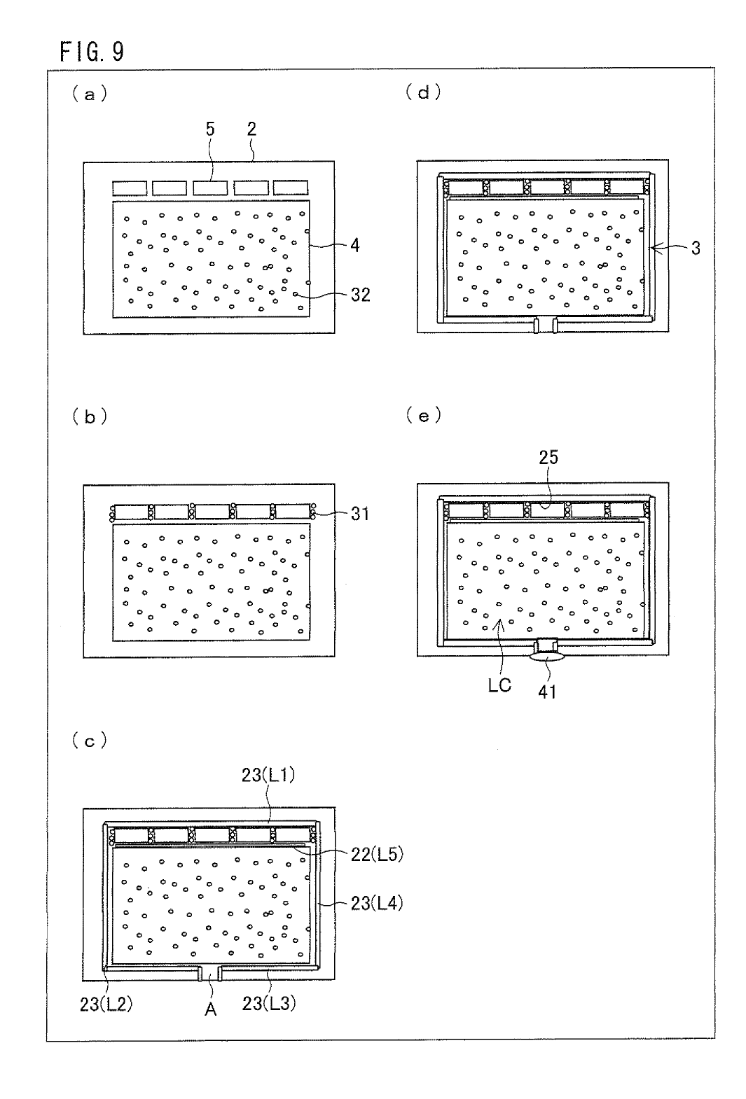

Note that it is also possible to carry out steps in which the liquid crystal LC is sealed in the injection method (see (a) through (e) of FIG. 9 obtained by modifying (a) through (e) of FIG. 8).

Steps identical to those of (a) and (b) of FIG. 8 are carried out (see (a) and (b) of FIG. 9). Next, the end-sealing member 23 is provided along the sides L1, L2, and L4, and the end-sealing member 22 is partially along the boundary L5, as is the case with (c) of FIG. 8 (see (c) of FIG. 9). The end-sealing member 23 is provided so that the side L3 has the filling hole A. The TFT substrate 2 and the counter substrate 3 are combined with each other (see (d) of FIG. 9). The liquid crystal is filled through the filling hole A by a vacuum filling, and thereafter the filling hole A is sealed with an end-sealing member 41 (see (e) of FIG. 9). The region where the display section 4 is provided and the region where the control circuit 5 is provided communicate with each other via a region where no end-sealing member 22 is provided along the boundary L5. As such, the liquid crystal LC is integrally sealed both in the region where the display section 4 is provided and in the region where the control circuit 5 is provided.

As described earlier, according to the present example, the liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a second end-sealing member provided between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the first region being end-sealed, with part of the first end-sealing member and the second end-sealing member, separately from the second region in which the liquid crystal is sealed.

According to the arrangement, the control circuit is away from each of the first and second end-sealing members, and the spacers maintain the distance between the matrix substrate and the counter substrate, in the first region. This allows the first region to be stably maintained as an end-sealing space. The control circuit is in contact with no first and second end-sealing members. This prevents a foreign material from moving and directly being intruded into the control circuit from the end-sealing member. Further, this also prevents the control circuit from being stressed.

Further, according to the present example, the liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a supporting member provided for supporting a gap between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the liquid crystal being integrally end-sealed with part of the first end-sealing member so that the first region and the second region communicate with each other.

According to the arrangement, the control circuit is away from each of the first end-sealing member and the supporting member, and the spacers maintain the distance between the matrix substrate and the counter substrate, in the first region. This allows the first region to be stably maintained as an end-sealing space. The control circuit is in contact with no first end-sealing member and no supporting member. This prevents a foreign material from moving and directly being intruded into the control circuit from the end-sealing member. Further, this also prevents the control circuit from being stressed.

As is clear from the above, it is possible to realize a liquid crystal display panel which is capable of preventing (i) intrusion of a foreign material in a control circuit from an end-sealing member and (ii) the control circuit from being stressed.

### Example 2

FIG. 2 illustrates another arrangement for the liquid crystal end-sealing of the present example.

The present example is obtained by replacing, with an end-sealing member 24, the end-sealing member 23 which is provided on the outer circumferential side of the liquid crystal display panel as compared to the control circuit 5 in the arrangement of FIG. 1 for the liquid crystal end-sealing. The sealing member 24, which is made of acrylic resin or thiol, is harder than each of the end-sealing members 22 and 23. The end-sealing member 24 is formed so as to cover (i) outsides of respective edges (outside the side L1) of the TFT substrate 2 and the counter substrate 3 which edges face each other and are located on the outer circumferential side of the liquid crystal display panel as compared to the control circuit 5 and (ii) the edges. The space 25 is a space decompressed by evacuation, as is the case with FIG. 1.

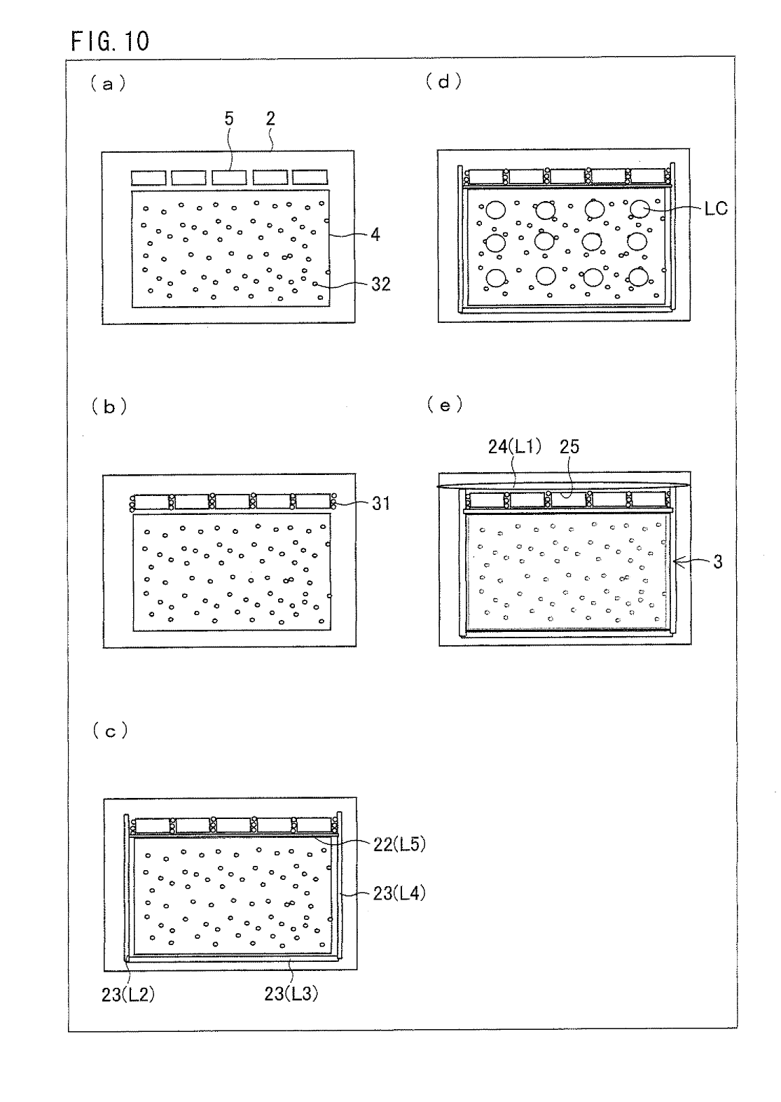

Next, the following describes a process for the liquid crystal end-sealing which is carried out in each of the liquid crystal display panels 1 and 10, with reference to (a) through (e) of FIG. 10.

The spacers 32 are dispersed in the region where the display section 4 is provided, the display section 4 and the control circuits 5 being provided on the TFT substrate 2 (see (a) of FIG. 10). The spacers 31 are provided, by the inkjet fixed-point dispersion, in the region where the control circuits 5 are provided, in a region such as a gap between the respective control circuits 5 (see (b) of FIG. 10). The end-sealing member 23 similar to that of FIG. 1 is provided along entire lengths of the respective sides L2, L3, and L4, and the end-sealing member 22 is provided along the entire length of the boundary L5 (see (c) of FIG. 10). In order that the liquid crystal is sealed in the ODF method, the liquid crystal LC is dropped in the region where the display section 4 is provided (see (d) of FIG. 10). The TFT substrate 2 and the counter substrate 3 are combined with each other, and UV curing or heat curing is then carried out, so that the liquid crystal is sealed (see (e) of FIG. 10). Subsequently, the end-sealing member 24 is formed so as to cover (i) outsides of respective edges (outside the side L1) of the TFT substrate 2 and the counter substrate 3 which edges face each other and are located on the outer circumferential side of the liquid crystal display panel as compared to the control circuit 5 and (ii) the edges. The space 25, defined by end-sealing the region where the control circuit is provided, is decompressed by evacuation.

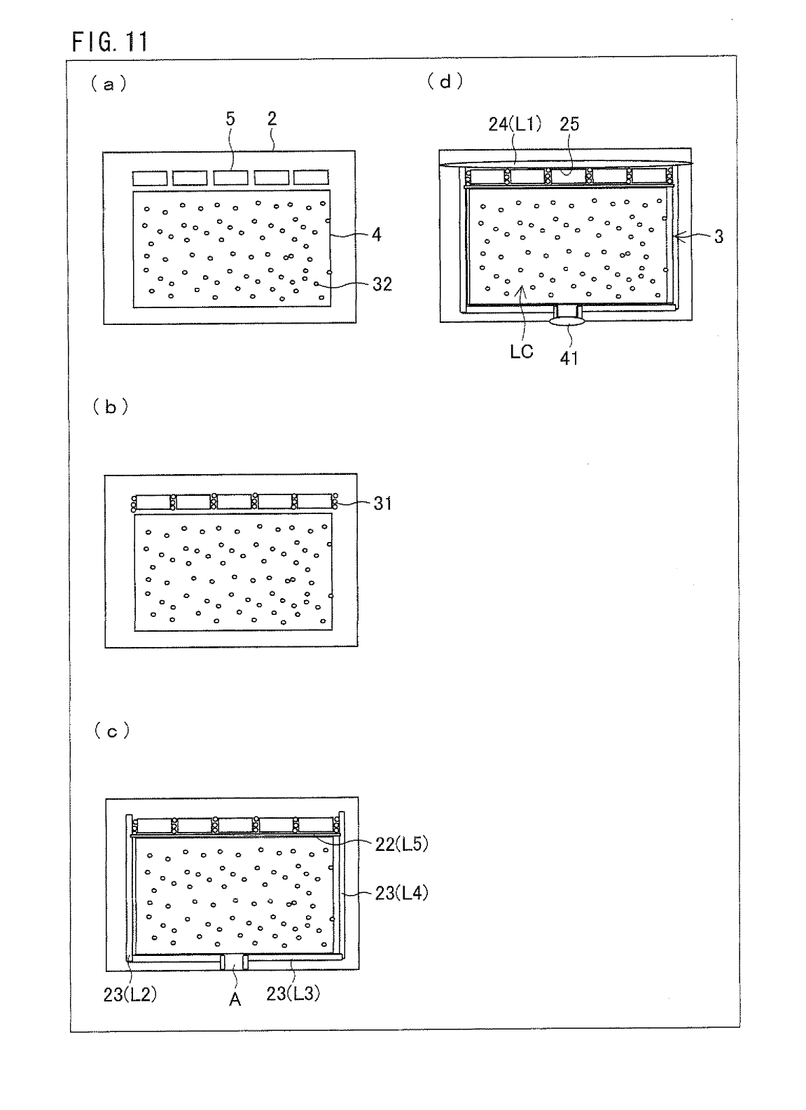

Note that it is also possible to carry out steps in which the liquid crystal LC is sealed in the injection method (see (a) through (d) of FIG. 11 obtained by modifying (a) through (e) of FIG. 10).

Steps identical to those of (a) and (b) of FIG. 10 are carried out (see (a) and (b) of FIG. 11). Next, the end-sealing member 23 is provided along the side L4, and the end-sealing member 22 is partially along the boundary L5, as is the case with (c) of FIG. 10 (see (c) of FIG. 11). The end-sealing member 23 is provided so that the side L3 has the filling hole A. The TFT substrate 2 and the counter substrate 3 are combined with each other. The liquid crystal is filled through the filling hole A by a vacuum filling, and thereafter the filling hole A is sealed with an end-sealing member 24 (see (d) of FIG. 11). The space 25, defined by end-sealing the region where the control circuit is provided, is decompressed by evacuation.

As described earlier, according to the present example, the liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a second end-sealing member provided between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the first region being end-sealed, with part of the first end-sealing member and the second end-sealing member, separately from the second region in which the liquid crystal is sealed.

According to the arrangement, the control circuit is away from each of the first and second end-sealing members, and the spacers maintain the distance between the matrix substrate and the counter substrate, in the first region. This allows the first region to be stably maintained as an end-sealing space. The control circuit is in contact with no first and second end-sealing members. This prevents a foreign material from moving and directly being intruded into the control circuit from the end-sealing member. Further, this also prevents the control circuit from being stressed.

Further, according to the present example, the liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a supporting member provided for supporting a gap between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the liquid crystal being integrally end-sealed with part of the first end-sealing member so that the first region and the second region communicate with each other.

According to the arrangement, the control circuit is away from each of the first end-sealing member and the supporting member, and the spacers maintain the distance between the matrix substrate and the counter substrate, in the first region. This allows the first region to be stably maintained as an end-sealing space. The control circuit is in contact with no first end-sealing member and no supporting member. This prevents a foreign material from moving and directly being intruded into the control circuit from the end-sealing member. Further, this also prevents the control circuit from being stressed.

As is clear from the above, it is possible to realize a liquid crystal display panel which is capable of preventing (i) intrusion of a foreign material in a control circuit from an end-sealing member and (ii) the control circuit from being stressed.

### Example 3

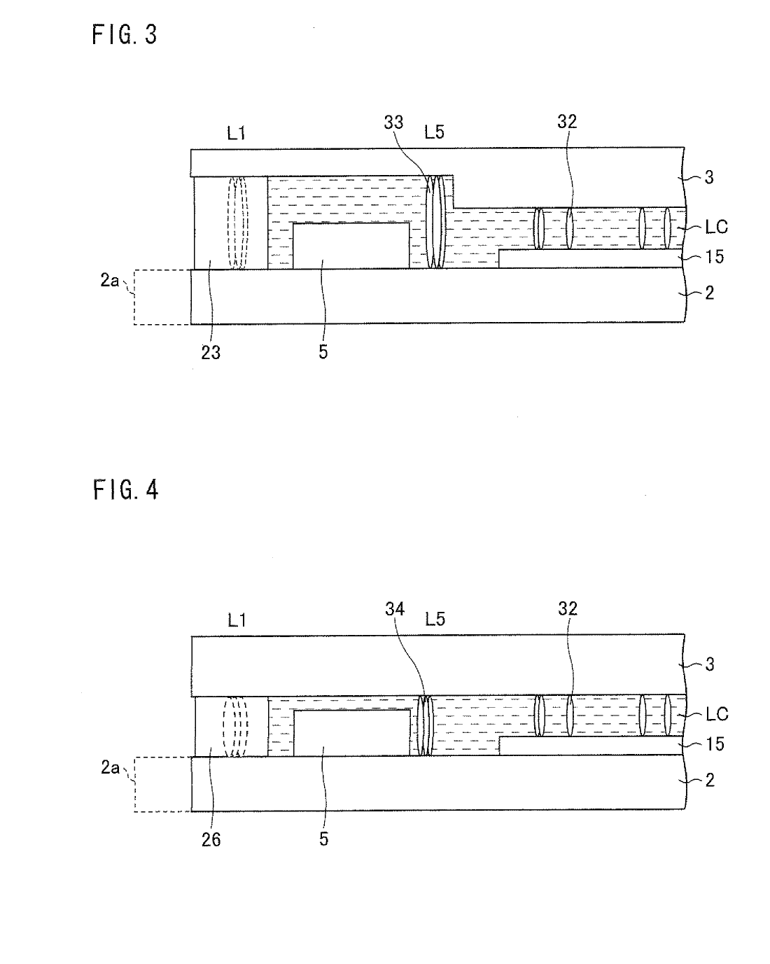

FIG. 3 illustrates a further arrangement for the liquid crystal end-sealing of the present example.

The present example is obtained (i) by replacing the end-sealing member 22 with spacers 33, (ii) by removing the spacers 31, and (iii) by filling the liquid crystal LC not only in the region where the display section 4 is provided but also in the region where the control circuit 5 is provided, in the arrangement for the liquid crystal end-sealing illustrated in FIG. 1. The spacers 33 are made of a material similar to that of the spacers 31, and have a size similar to that of the spacers 31. The spacers 33 are provided along the boundary L5 by the inkjet fixed-point dispersion.

A method such as the ODF method or the injection method can be employed for the liquid crystal end-sealing

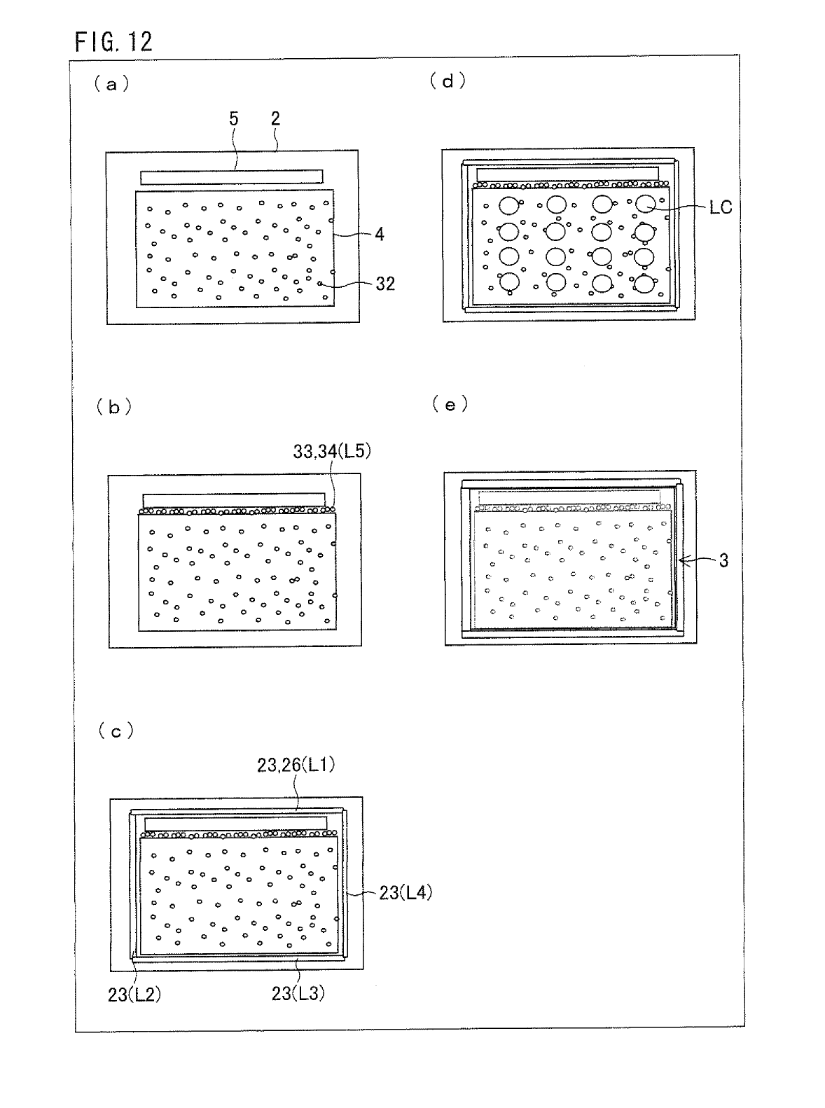

Next, the following describes a process for the liquid crystal end-sealing which is carried out in the liquid crystal display panel 1, with reference to (a) through (e) of FIG. 12.

The spacers 32 are dispersed in the region where the display section 4 is provided, the display section 4 and the control circuits 5 being provided on the TFT substrate 2 (see (a) of FIG. 12). Note here that the control circuit 5 does not necessarily include a plurality of control circuits (as illustrated in each of FIGS. 7 through 11) which are adjacent to each other. The spacers 33 are provided along the boundary L5 by the inkjet fixed-point dispersion (see (b) of FIG. 12). The end-sealing member 23 is provided along entire lengths of the respective sides L1, L2, L3, and L4, and the end-sealing member 22 is provided along the entire length of the boundary L5 (see (e) of FIG. 12). In order that the liquid crystal is sealed in the ODF method, the liquid crystal LC is dropped in the region where the display section 4 is provided (see (d) of FIG. 12). The TFT substrate 2 and the counter substrate 3 are combined with each other, and UV curing or heat curing is then carried out, so that the liquid crystal is sealed (see (e) of FIG. 12). The region where the display section 4 is provided and the region where the control circuit 5 is provided communicate with each other via a region where no end-sealing member 22 is provided along the boundary L5. As such, the liquid crystal LC is integrally sealed both in the region where the display section 4 is provided and in the region where the control circuit 5 is provided.

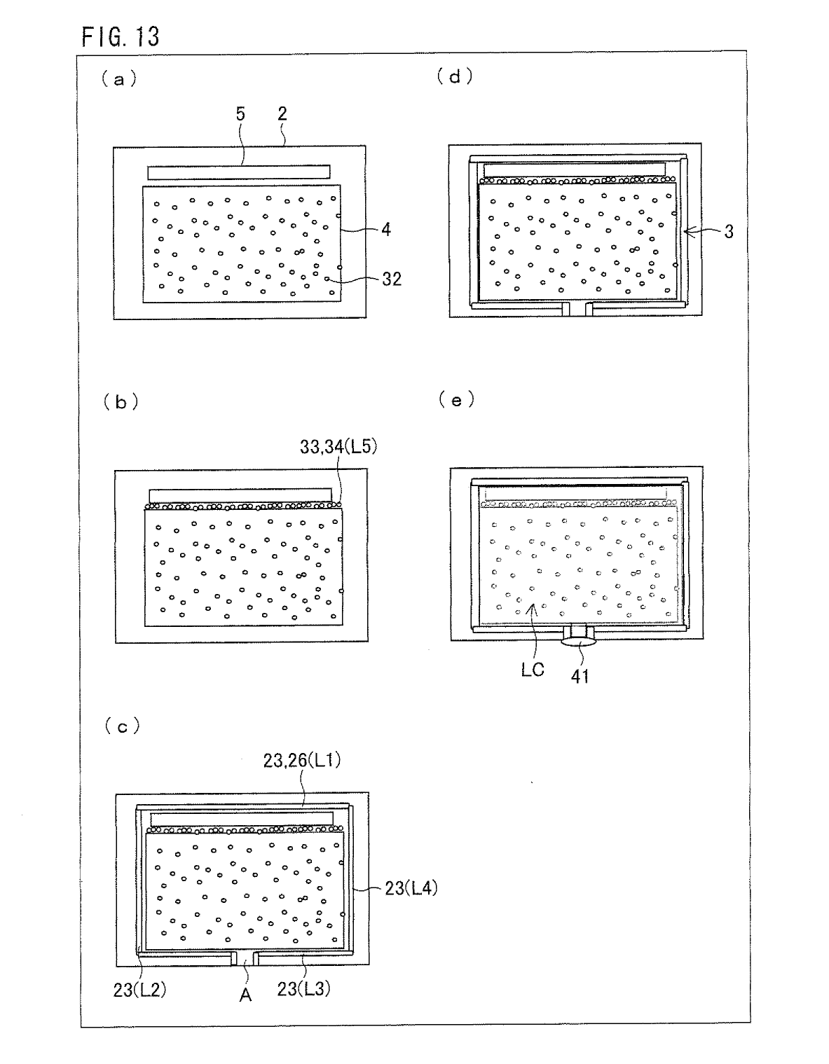

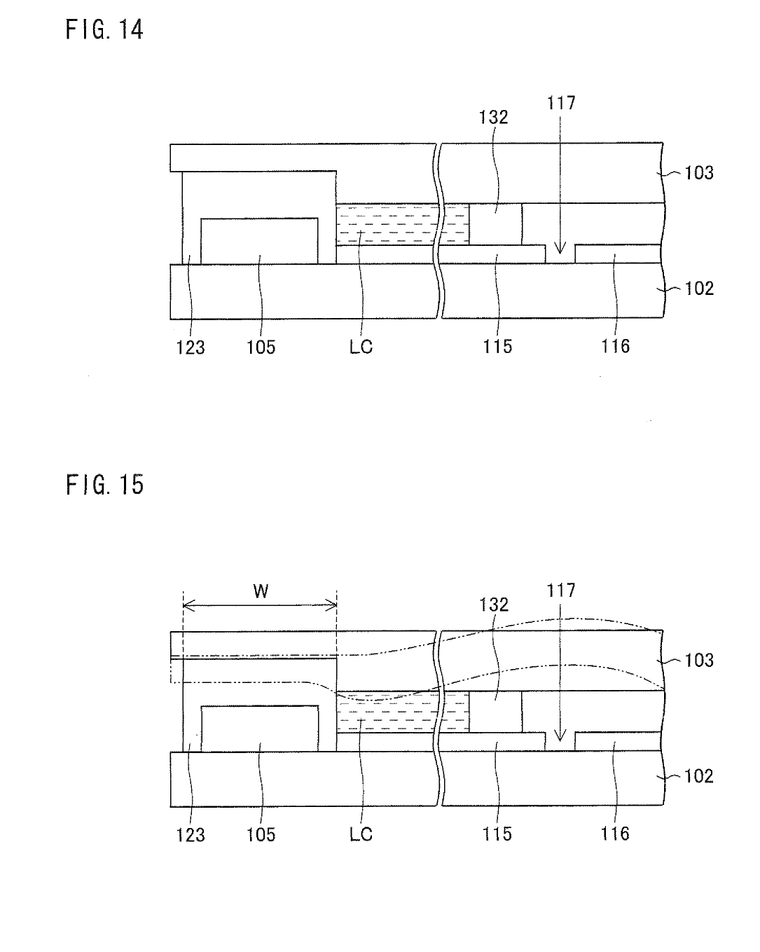

Note that it is also possible to carry out steps in which the liquid crystal LC is sealed in the injection method (see (a) through (e) of FIG. 13 obtained by modifying (a) through (e) of FIG. 12).

Steps identical to those of (a) and (b) of FIG. 12 are carried out (see (a) and (b) of FIG. 13). Next, the end-sealing member 23 is provided along the sides L1, L2, and L4, as is the case with (c) of FIG. 12 (see (c) of FIG. 13). The end-sealing member 23 is provided so that the side L3 has the filling hole A. The TFT substrate 2 and the counter substrate 3 are combined with each other. The liquid crystal is filled through the filling hole A by a vacuum filling, and thereafter the filling hole A is sealed with an end-sealing member 41 (see (d) of FIG. 13). The region where the display section 4 is provided and the region where the control circuit 5 is provided communicate with each other via a region where no end-sealing member 22 is provided along the boundary L5. As such, the liquid crystal LC is integrally sealed both in the region where the display section 4 is provided and in the region where the control circuit 5 is provided.

As described earlier, according to the present example, the liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; and spacers, provided along a boundary between (a) a first region where the control circuit is provided and (b) a second region where the display section is provided, for maintaining, in a region corresponding to the first region, a distance between the matrix substrate and the counter substrate, the liquid crystal being integrally end-sealed with part of the first end-scaling member so that the first region and the second region communicate with each other.

According to the arrangement, the control circuit is away from the first end-sealing member, and the spacers maintain the distance between the matrix substrate and the counter substrate, along the boundary between the first region and the second region. This allows the first region to be stably maintained as an end-sealing space. The control circuit is in contact with no first member. This prevents a foreign material from moving and directly being intruded into the control circuit from the end-sealing member. Further, this also prevents the control circuit from being stressed.

As is clear from the above, it is possible to realize a liquid crystal display panel which is capable of preventing (1) intrusion of a foreign material in a control circuit from an end-sealing member and (ii) the control circuit from being stressed.

### Example 4

FIG. 4 illustrates still a further arrangement for the liquid crystal end-sealing of the present example.

The present example is arranged such that: in a case where the control circuit 5 is not so large in height, the counter substrate 3 has a uniform thickness, the end-sealing member 26 is provided along the entire length of the side L1, and spacers 34 are dispersed along the boundary L5. The end-sealing member 26 is made of a material similar to that of the end-sealing member 23. The spacers 34 are made of a material similar to that of the spacers 31, and the spacers 34 are larger than the spacers 32. The spacers 34 are provided along the boundary L5 by the inkjet fixed-point dispersion.

The liquid crystal LC is sealed both in the region where the display section 4 is provided and in the region where the control circuit 5 is provided. A method such as the ODF method or the injection method can be employed for the liquid crystal end-sealing

A process for the liquid crystal end-sealing which is carried out in the liquid crystal display panel 1 in accordance with the present example is similar to the process of FIG. 12 which process includes the steps (a) through (e).

The spacers 32 are dispersed in the region where the display section 4 is provided, the display section 4 and the control circuits 5 being provided on the TFT substrate 2 (see (a) of FIG. 12). Note here that the control circuit 5 does not necessarily include a plurality of control circuits (as illustrated in each of FIGS. 7 through 11) which are adjacent to each other. The spacers 34 are provided along the boundary L5 by the inkjet fixed-point dispersion (see (b) of FIG. 12). The end-sealing member 26 is provided along an entire length of the side L1, and the end-sealing member 23 is provided along entire lengths of the respective sides L2, L3, and L4 (see (c) of FIG. 12). In order that the liquid crystal is sealed in the ODF method, the liquid crystal LC is dropped in the region where the display section 4 is provided (see (d) of FIG. 12). The TFT substrate 2 and the counter substrate 3 are combined with each other, and UV curing or heat curing is then carried out, so that the liquid crystal is sealed (see (e) of FIG. 12). The region where the display section 4 is provided and the region where the control circuit 5 is provided communicate with each other via a region where no end-sealing member 22 is provided along the boundary L5. As such, the liquid crystal LC is integrally sealed both in the region where the display section 4 is provided and in the region where the control circuit 5 is provided.

Note that it is also possible to carry out steps in which the liquid crystal LC is sealed in the injection method (see (a) through (e) of FIG. 13).

Steps identical to those of (a) and (b) of FIG. 12 are carried out (see (a) and (b) of FIG. 13). Next, the end-sealing member 26/23 is provided along the sides L1, L2, and L4, as is the case with (c) of FIG. 12 (see (c) of FIG. 13). The end-sealing member 23 is provided so that the side L3 has the filling hole A. The TFT substrate 2 and the counter substrate 3 are combined with each other. The liquid crystal is filled through the filling hole A by a vacuum filling, and thereafter the filling hole A is sealed with an end-sealing member 41 (see (d) of FIG. 13). The region where the display section 4 is provided and the region where the control circuit 5 is provided communicate with each other via a region where no end-sealing member 22 is provided along the boundary L5. As such, the liquid crystal LC is integrally sealed both in the region where the display section 4 is provided and in the region where the control circuit 5 is provided.

As described earlier, according to the present example, the liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; and spacers, provided along a boundary between (a) a first region where the control circuit is provided and (b) a second region where the display section is provided, for maintaining, in a region corresponding to the first region, a distance between the matrix substrate and the counter substrate, the liquid crystal being integrally end-sealed with part of the first end-sealing member so that the first region and the second region communicate with each other.

According to the arrangement, the control circuit is away from the first end-sealing member, and the spacers maintain the distance between the matrix substrate and the counter substrate, along the boundary between the first region and the second region. This allows the first region to be stably maintained as an end-sealing space. The control circuit is in contact with no first member. This prevents a foreign material from moving and directly being intruded into the control circuit from the end-sealing member. Further, this also prevents the control circuit from being stressed.

As is clear from the above, it is possible to realize a liquid crystal display panel which is capable of preventing (i) intrusion of a foreign material in a control circuit from an end-sealing member and (ii) the control circuit from being stressed.

The present invention is not limited to the description of the embodiments, but may be altered by a skilled person in the art within the scope of the claims. An embodiment based on a proper combination of technical means disclosed in different embodiments is encompassed in the technical scope of the present invention.

As described earlier, a liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a second end-sealing member provided between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the first region being end-sealed, with part of the first end-sealing member and the second end-sealing member, separately from the second region in which the liquid crystal is sealed.

As described earlier, a liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; a supporting member provided for supporting a gap between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and spacers provided in the fourth region included in the first region, so as to maintain a distance between the matrix substrate and the counter substrate, the liquid crystal being integrally end-sealed with part of the first end-sealing member so that the first region and the second region communicate with each other.

As described earlier, a liquid crystal display panel of the present invention including: liquid crystal provided between a matrix substrate and a counter substrate; a control circuit; and a display section, the control circuit being provided on the matrix substrate, and controlling a matrix circuit, and the display section including the matrix circuit, the liquid crystal display panel further includes: a first end-sealing member provided between the matrix substrate and the counter substrate, on an outer circumferential side of the liquid crystal display panel as compared to the control circuit, so as to be away from the control circuit; and spacers, provided along a boundary between (a) a first region where the control circuit is provided and (b) a second region where the display section is provided, for maintaining, in a region corresponding to the first region, a distance between the matrix substrate and the counter substrate, the liquid crystal being integrally end-sealed with part of the first end-sealing member so that the first region and the second region communicate with each other.

The above brings about an effect of realizing a liquid crystal display panel which is capable of preventing (i) intrusion of a foreign material in a control circuit from an end-sealing member and (ii) the control circuit from being stressed.

The embodiments and concrete examples discussed in the detailed description serve solely to illustrate the technical details of the present invention, which should not be narrowly interpreted within the limits of such embodiments and concrete examples, but rather can be modified in many ways within the spirit of the present invention, provided that such modifications do not exceed the scope of the patent claims set forth below.

### INDUSTRIAL APPLICABILITY

The present invention is suitably applicable to a liquid crystal display panel on which a control circuit is provided.

1. A liquid crystal display panel including: liquid crystal provided between a matrix substrate and a counter substrate; a control circuit; and a display section, the control circuit being provided on the matrix substrate, and controlling a matrix circuit, and the display section including the matrix circuit,
the liquid crystal display panel further comprising:
a first end-sealing member provided between the matrix substrate and the counter substrate, on an outer circumferential side of the liquid crystal display panel as compared to the control circuit, so as to be away from the control circuit;
a second end-sealing member provided between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and
spacers provided in the fourth region included in the first region, so as to maintain a distance between the matrix substrate and the counter substrate,
the first region being end-sealed, with part of the first end-sealing member and the second end-sealing member, separately from the second region in which the liquid crystal is sealed.

2. The liquid crystal display panel as set forth in claim 1, wherein a space, defined by end-sealing the first region, is decompressed.

3. The liquid crystal display panel as set forth in claim 1, wherein the first end-sealing member is provided so as to cover outsides of respective edges of the matrix substrate and the counter substrate, which edges are located on the outer circumferential side of the liquid crystal display panel as compared to the control circuit.

4. The liquid crystal display panel as set forth in claim 1, wherein each of the first end-sealing member and the second end-sealing member is made of modified epoxy acrylate.

5. The liquid crystal display panel as set forth in 1, wherein the first end-sealing member is made of a harder material than the second end-sealing member.

6. The liquid crystal display panel as set forth in claim 5, wherein the first end-sealing member is made of acrylic resin or thiol, and the second end-sealing member is made of modified epoxy acrylate.

7. The liquid crystal display panel as set forth in claim 1, wherein each of the first end-sealing member and the second end-sealing member includes glass spacers.

8. The liquid crystal display panel as set forth in claim 1, wherein a first part of the counter substrate, which part faces the matrix substrate and corresponds to: (i) the first region, (ii) a region where the first end-sealing member is provided, and (iii) a region where the second end-sealing member is provided, is removed from the counter substrate so that a second part of the counter substrate obtained after the first part is removed has a smaller thickness than a third part of the counter substrate which part corresponds to the second region.

9. A liquid crystal display panel including: liquid crystal provided between a matrix substrate and a counter substrate; a control circuit; and a display section, the control circuit being provided on the matrix substrate, and controlling a matrix circuit, and the display section including the matrix circuit,
the liquid crystal display panel further comprising:
a first end-sealing member provided between the matrix substrate and the counter substrate, on an outer circumferential side of the liquid crystal display panel as compared to the control circuit, so as to be away from the control circuit;
a supporting member provided for supporting a gap between the matrix substrate and the counter substrate, along a boundary between (a) a first region where the control circuit is provided and (b) a second region where the display section is provided, the first region including: a third region which is allotted for the control circuit; and a fourth region which is allotted for no control circuit, so as to be away from the control circuit; and
spacers provided in the fourth region included in the first region, so as to maintain a distance between the matrix substrate and the counter substrate,
the liquid crystal being integrally end-sealed with part of the first end-sealing member so that the first region and the second region communicate with each other.

10. The liquid crystal display panel as set forth in claim 9, wherein a first part of the counter substrate, which part faces the matrix substrate and corresponds to: (i) the first region, (ii) a region where the first end-sealing member is provided, and (iii) a region where the supporting member is provided, is removed from the counter substrate so that a second part of the counter substrate obtained after the first part is removed has a smaller thickness than a third part of the counter substrate which part corresponds to the second region.

11. The liquid crystal display panel as set forth in claim 9, wherein each of the first end-scaling member and the supporting member includes glass spacers.

12. The liquid crystal display panel as set forth in claim 1, wherein the spacers provided in the first region are larger than spacers provided in the liquid crystal provided in the second region.

13. The liquid crystal display panel as set forth in claim 1, wherein the spacers provided in the first region are made of a photospacer or a plastic bead.

14. A liquid crystal display panel including: liquid crystal provided between a matrix substrate and a counter substrate; a control circuit; and a display section, the control circuit being provided on the matrix substrate, and controlling a matrix circuit, and the display section including the matrix circuit,
the liquid crystal display panel further comprising:
a first end-sealing member provided between the matrix substrate and the counter substrate, on an outer circumferential side of the liquid crystal display panel as compared to the control circuit, so as to be away from the control circuit; and
spacers, provided along a boundary between (a) a first region where the control circuit is provided and (b) a second region where the display section is provided, for maintaining, in a region corresponding to the first region, a distance between the matrix substrate and the counter substrate,
the liquid crystal being integrally end-sealed with part of the first end-sealing member so that the first region and the second region communicate with each other.

15. The liquid crystal display panel as set forth in claim 14, wherein a first part of the counter substrate, which part faces the matrix substrate and corresponds to: (i) the first region, (ii) a region where the first end-sealing member is provided, and (iii) a region where the spacers are provided, is removed from the counter substrate so that a second part of the counter substrate obtained after the first part is removed has a smaller thickness than a third part of the counter substrate which part corresponds to the second region.

16. The liquid crystal display panel as set forth in claim 14, wherein the counter substrate has a uniform thickness.

17. The liquid crystal display panel as set forth in claim 14, wherein the first end-sealing member is made of modified epoxy acrylate.

18. The liquid crystal display panel as set forth in 14, wherein the first end-sealing member includes glass spacers.

19. The liquid crystal display panel as set forth in claim 14, wherein the spacers provided along the boundary between the first region and the second region are larger than spacers provided in the liquid crystal provided in the second region.

20. The liquid crystal display panel as set forth in claim 14, wherein the spacers provided along the boundary between the first region and the second region are made of a photospacer or a plastic bead.

21. The liquid crystal display panel as set forth in claim 1, wherein the control circuit has a height from a top surface of the matrix substrate which height is higher than the matrix circuit in the second region.

22. The liquid crystal display panel as set forth in claim 1, wherein the control circuit is made of CG silicon which is formed on the matrix substrate.

23. The liquid crystal display panel as set forth in claim 1, wherein the control circuit is mounted on the matrix substrate in a COG method.
